(19) United States
(12) Patent Application Publication
(10) Pub. No.: US 2024/0430822 A1
(43) Pub. Date: Dec. 26, 2024

(54) MULTI-CONNECTION RADIO FREQUENCY (RF) EXPOSURE COMPLIANCE

(71) Applicant: QUALCOMM Incorporated, San Diego, CA (US)

(72) Inventors: Venkatesh SASANAPURI, Hyderabad (IN); Michael Siddhartha ARPUTHARAJ, Hyderabad (IN); Narasimhamurthy VEMPATI, Hyderabad (IN); Kaushik BHATTACHARYA, Hyderabad (IN); Suman CHAKRABORTY, Hyderabad (IN)

(21) Appl. No.: 18/340,285

(22) Filed: Jun. 23, 2023

(51) Int. Cl. H04W 52/36; H04W 52/22

(52) U.S. Cl. CPC H04W 52/367; H04W 52/225; H04W 84/12

(57) ABSTRACT

Certain aspects of the present disclosure provide techniques and apparatus for multi-connection radio frequency (RF) exposure compliance. An example method of wireless communication includes obtaining a transmit power budget associated with a time interval. The method further includes determining transmit powers on a per-connection basis among a plurality of connections based at least in part on the transmit power budget and one or more characteristics associated with the connections. The method further includes transmitting signals associated with the connections at the respective transmit powers in the time interval.

### BACKGROUND

### Field of the Disclosure

Aspects of the present disclosure relate to wireless communications, and more particularly, to radio frequency (RF) exposure compliance.

### Description of Related Art

Wireless communication systems are widely deployed to provide various telecommunication services such as telephony, video, data, messaging, broadcasts, etc. Modern wireless communication devices (such as cellular telephones) are generally mandated to meet radio frequency (RF) exposure limits set by certain governments and international standards and regulations. To ensure compliance with the standards, such devices may undergo an extensive certification process prior to being shipped to market. To ensure that a wireless communication device complies with an RF exposure limit, techniques have been developed to enable the wireless communication device to assess RF exposure from the wireless communication device and adjust the transmit power of the wireless communication device accordingly to comply with the RF exposure limit.

### SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description,” one will understand how the features of this disclosure provide the advantages described herein.

Some aspects provide a method of wireless communication by a wireless device. The method includes obtaining a transmit power budget associated with a time interval. The method further includes determining transmit powers on a per-connection basis among a plurality of connections based at least in part on the transmit power budget and one or more characteristics associated with the connections. The method further includes transmitting signals associated with the connections at the respective transmit powers in the time interval.

Some aspects provide an apparatus for wireless communication. The apparatus includes a memory and a processor coupled to the memory. The processor is configured to obtain a transmit power budget associated with a time interval, determine transmit powers on a per-connection basis among a plurality of connections based at least in part on the transmit power budget and one or more characteristics associated with the connections, and control transmission of signals associated with the connections at the respective transmit powers in the time interval.

Some aspects provide an apparatus for wireless communication. The apparatus includes means for obtaining a transmit power budget associated with a time interval. The apparatus further includes means for determining transmit powers on a per-connection basis among a plurality of connections based at least in part on the transmit power budget and one or more characteristics associated with the connections. The apparatus further includes means for transmitting signals associated with the connections at the respective transmit powers in the time interval.

Some aspects provide a computer-readable medium. The computer-readable medium has instructions stored thereon for obtaining a transmit power budget associated with a time interval, determining transmit powers on a per-connection basis among a plurality of connections based at least in part on the transmit power budget and one or more characteristics associated with the connection, and transmitting signals associated with the connections at the respective transmit powers in the time interval.

Other aspects provide: an apparatus operable, configured, or otherwise adapted to perform any one or more of the aforementioned methods and/or those described elsewhere herein; a non-transitory, computer-readable medium comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication network exhibiting radio frequency (RF) exposure to a human.

FIG. 2 is a block diagram conceptually illustrating a design of an example a wireless communication device communicating with another device.

FIG. 3 is a graph illustrating examples of transmit powers over time in compliance with an RF exposure limit.

FIG. 4 is a block diagram illustrating an example multi-link operation among multi-link devices.

FIG. 5 is a diagram illustrating an example wireless device having multiple radios.

FIG. 6 is a diagram illustrating an example logical architecture for controlling a transmit power associated with one or more radios.

FIG. 7 is a flow diagram illustrating example operations for wireless communication by a wireless device.

FIG. 8 illustrates a communications device that may include various components configured to perform operations for the techniques disclosed herein.

To facilitate understanding, identical reference numerals have been used, where possible, to designate identical elements that are common to the figures. It is contemplated that elements disclosed in one aspect may be beneficially utilized in other aspects without specific recitation.

### DETAILED DESCRIPTION

Aspects of the present disclosure provide apparatus, methods, processing systems, and computer-readable mediums for multi-connection radio frequency (RF) exposure compliance.

A wireless communication device may be capable of communicating via multiple radio access technologies (RATs), such as wireless wide area network (WWAN) RAT(s) (e.g., 5G New Radio, Evolved Universal Terrestrial Radio Access (E-UTRA), Universal Mobile Telecommunications System (UMTS) and/or code division multiple access (CDMA)), wireless local area network (WLAN) RATs (e.g., IEEE 802.11), short-range communications (e.g., Bluetooth), non-terrestrial communications, device-to-device (D2D) communications, vehicle-to-everything (V2X) communications, and/or other communications (e.g., future RAT(s)). In some cases, the wireless device may control RF exposure using a centralized controller that controls the transmit power (and hence, the RF exposure) associated with particular radios for one or more RATs.

To control the RF exposure associated with multiple radios (e.g., WLAN, WWAN (E-UTRA/5G), and Bluetooth), a time-averaged evaluation may have two components: an outer loop (OL) that periodically determines the transmit power limit for each of the radios, and an inner loop (IL) for each of the radios that uses the respective transmit power limit to determine its transmit power for a specific time interval of a running time window or for each packet. The OL may compute the transmit power limit based on a transmit power history report provided by the inner loop associated with each of the radios, where the transmit power history report may indicate the transmit powers used over time in the previous time interval(s).

In certain cases, the IL associated with one or more radios (e.g., WWAN radio(s), WLAN radio(s)) may not distinguish between multiple concurrent connections (e.g., connections corresponding to multiple links and/or multiple peers in a WWAN and/or WLAN) when allocating transmit powers to such connections. The IL may not consider certain characteristics associated with the connections in determining the transmit powers for the connections. For example, the wireless device may not consider the transmission distance associated with each of the connections in determining the transmit powers. As an example, the wireless device may allocate the same transmit power to the peers that are the closest to and farthest from the wireless device. As such, the transmit power budget may not be efficiently distributed among the connections, which may result in reduced performance for some connections.

Aspects of the present disclosure provide apparatus and methods for multi-connection RF exposure compliance. A wireless device may distribute a transmit power budget among multiple connections on a per-connection basis considering one or more characteristics associated with the connections. For example, the wireless device may allocate separate transmit powers for the connections based on a distance to each of the peers associated with the connections. The characteristics may include, for example, a signal strength, a data error rate, a round-trip time, a duty cycle, etc. The connections may be associated with WLAN communications, such as multiple links in multi-link operation (MLO) and/or multiple peers. In some examples, the transmit power budget may be distributed among the connections using a constrained optimization method, such as a Lagrange multiplier.

The apparatus and methods for multi-connection RF exposure compliance described herein may provide various advantages. For example, the multi-connection aware RF exposure compliance may improve wireless communication performance, including, for example, an increased throughput, decreased latency, and/or increased transmission range, where the improved performance may be attributable to efficient distribution of transmit powers to multiple connections. For example, the wireless device may distribute a smaller share of a transmit power budget to a peer that is closer to the wireless device and larger share of the transmit power budget to another peer that is farther from the wireless device.

As used herein, a radio may refer to a physical or logical transmission path associated with one or more frequency bands (carriers, channels, bandwidths, subdivisions thereof, etc.), transceivers, and/or radio access technologies (RATs) (e.g., wireless wide area network (WWAN), wireless local area network (WLAN), short-range communications (Bluetooth), non-terrestrial communications, vehicle-to-everything (V2X) communications, etc.) used for wireless communications. For example, for uplink carrier aggregation (or multi-connectivity) in WWAN communications, each of the active component carriers used for wireless communications may be treated as a separate radio. Similarly, multi-band transmissions for IEEE 802.11 may be treated as separate radios for each frequency band (e.g., 2.4 GHz, 5 GHZ, or 6 GHZ).

### Example RF Exposure Compliance

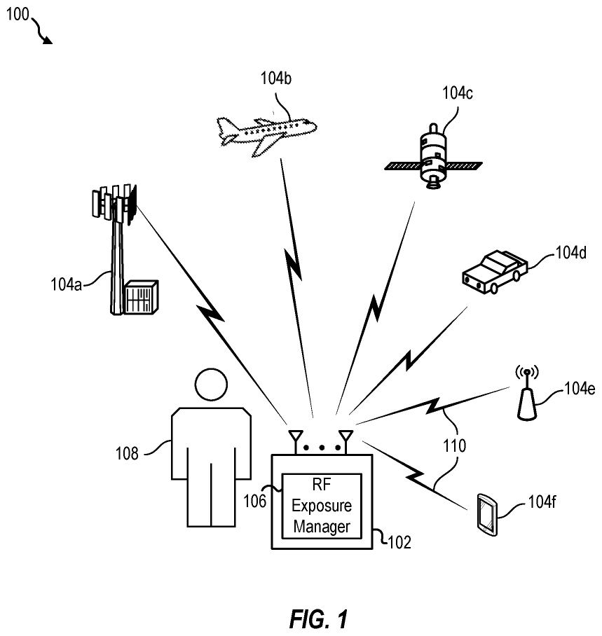

FIG. 1 illustrates an example wireless communication system 100 in which aspects of the present disclosure may be performed. For example, the wireless communication system 100 may include a wireless wide area network (WWAN) and/or a wireless local area network (WLAN). For example, a WWAN may include a New Radio system (e.g., a 5G NR network), an Evolved Universal Terrestrial Radio Access (E-UTRA) system (e.g., a 4G network), a Universal Mobile Telecommunications System (UMTS) (e.g., a 2G/3G network), a code division multiple access (CDMA) system (e.g., a 2G/3G network), any future WWAN system, or any combination thereof. A WLAN may include a wireless network configured for communications according to an IEEE standard such as one or more of the 802.11 standards, etc. In some cases, the wireless communication system 100 may include a device-to-device (D2D) communications network or a short-range communications system, such as Bluetooth communications.

As illustrated in FIG. 1, the wireless communication system 100 may include a first wireless device 102 communicating with any of various second wireless devices 104a-f (a second wireless device 104) via any of various radio access technologies (RATs), where a wireless device may refer to a wireless communication device. The RATs may include, for example, WWAN communications (e.g., E-UTRA and/or 5G NR), WLAN communications (e.g., IEEE 802.11), vehicle-to-everything (V2X) communications, non-terrestrial network (NTN) communications, short-range communications (e.g., Bluetooth), etc.

The first wireless device 102 may be emitting RF signals in proximity to a human 108, who may be the user of the first wireless device 102 and/or a bystander. As an example, the first wireless device 102 may be held in the hand of the human 108 and/or positioned against or near the head of the human 108. In certain cases, the first wireless device 102 may be positioned in a pocket or bag of the human 108. In some cases, the first wireless device 102 may be positioned proximate to the human 108 as a mobile hotspot. To ensure the human 108 is not overexposed to RF emissions from the first wireless device 102, the first wireless device 102 may control the transmit power associated with the RF signals in accordance with an RF exposure limit, as further described herein, where the RF exposure limit may depend on corresponding exposure scenario (e.g., head exposure, extremity (e.g., hand) exposure, body (body-worn) exposure, hotspot exposure, etc.). Extremities may include, for example, hands, wrists, feet, ankles, and pinnae.

The first wireless device 102 may include any of various wireless communication devices including a user equipment (UE), a wireless station, an access point, a customer-premises equipment (CPE), etc. In certain aspects, the first wireless device 102 includes an RF exposure manager 106 that determines transmit powers on a per-connection basis based on characteristic(s) associated with the connections, in accordance with aspects of the present disclosure.

The second wireless devices 104a-f may include, for example, a base station 104a, an aircraft 104b, a satellite 104c, a vehicle 104d, an access point (AP) 104e, and/or a UE 104f. Further, the wireless communication system 100 may include terrestrial aspects, such as ground-based network entities (e.g., the base station 104a and/or access point 104e), and/or non-terrestrial aspects, such as the aircraft 104b and the satellite 104c, which may include network entities on-board (e.g., one or more base stations) capable of communicating with other network elements (e.g., terrestrial base stations) and/or user equipment.

The base station 104a may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. The base station 104a may provide communications coverage for a respective geographic coverage area, which may sometimes be referred to as a cell, and which may overlap in some cases (e.g., a small cell may have a coverage area that overlaps the coverage area of a macro cell). A base station may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

The first wireless device 102 and/or the UE 104f may generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device (e.g., a watch, a ring, headphones, earbuds, a virtual (or augmented) reality headset, etc.), vehicle, electric meter, gas pump, large or small kitchen appliance, healthcare device, implant, sensor/actuator, display, internet of things (IoT) devices, always on (AON) devices, edge processing devices, or other similar devices. A UE may also be referred to more generally as a mobile device, a wireless device, a wireless communications device, a wireless station (STA), a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and other terms.

According to some aspects, the wireless communication system 100 can include a WLAN, such as a Wi-Fi network. For example, the wireless communication system 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8). The wireless communication system 100 may include numerous wireless communication devices such as wireless AP(s) and STAs. For example, the first wireless device 102, the second wireless device 104, and the UE 104f may be representative of an AP and/or STA. As an example, in some cases, the first wireless device 102 may operate as an AP and/or a STA. The wireless communication system 100 can include multiple APs, including the AP 104c and/or the first wireless device 102. The AP can represent various different types of APs including but not limited to enterprise-level APs, single-frequency APs, dual-band APs, standalone APs, software-enabled APs (soft APs), and multi-link APs. The coverage area and capacity of a cellular network (such as E-UTRA, 5G NR, etc.) can be further improved by a small cell which is supported by an AP serving as a miniature base station. Furthermore, private cellular networks also can be set up through a wireless area network using small cells.

A single AP and an associated set of STAs may be referred to as a basic service set (BSS), which is managed by the respective AP. The coverage area of the AP may represent a basic service area (BSA) of the wireless communication system 100. The BSS may be identified or indicated to users by a service set identifier (SSID), as well as to other devices by a basic service set identifier (BSSID), which may be a medium access control (MAC) address of the AP. The AP may periodically broadcast beacon frames (“beacons”) including the BSSID to enable any STAs within wireless range of the AP to “associate” or re-associate with the AP to establish a respective communication link 110, or to maintain a communication link 110, with the AP. For example, the beacons can include an identification or indication of a primary channel used by the respective AP as well as a timing synchronization function for establishing or maintaining timing synchronization with the AP. The AP may provide access to external networks to various STAs in the WLAN via respective communication links 110.

To establish a communication link 110 with an AP, each of the STAs is configured to perform passive or active scanning operations (“scans”) on frequency channels in one or more frequency bands (for example, the 2.4 GHZ, 5 GHZ, 6 GHZ, or 60 GHz bands). To perform passive scanning, a STA listens for beacons, which are transmitted by respective APs at a periodic time interval referred to as the target beacon transmission time (TBTT) (measured in time units (TUs) where one TU may be equal to 1024 microseconds (μs)). To perform active scanning, a STA generates and sequentially transmits probe requests on each channel to be scanned and listens for probe responses from APs. Each STA may identify, determine, ascertain, or select an AP with which to associate in accordance with the scanning information obtained through the passive or active scans, and to perform authentication and association operations to establish a communication link 110 with the selected AP. The AP assigns an association identifier (AID) to the STA at the culmination of the association operations, which the AP uses to track the STA.

As a result of the increasing ubiquity of wireless networks, a STA may have the opportunity to select one of many BSSs within range of the STA or to select among multiple APs that together form an extended service set (ESS) including multiple connected BSSs. An extended network station associated with the wireless communication system 100 may be connected to a wired or wireless distribution system that may allow multiple APs to be connected in such an ESS. As such, a STA can be covered by more than one AP and can associate with different APs at different times for different transmissions. Additionally, after association with an AP, a STA also may periodically scan its surroundings to find a more suitable AP with which to associate. For example, a STA that is moving relative to its associated AP may perform a “roaming” scan to find another AP having more desirable network characteristics such as a greater received signal strength indicator (RSSI) or a reduced traffic load.

In some cases, STAs may form networks without APs or other equipment other than the STAs themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the wireless communication system 100. In such examples, while the STAs may be capable of communicating with each other through the AP using communication links 110, STAs also can communicate directly with each other via direct wireless communication links 110. For example, the first wireless device 102 may communicate directly with the UE 104f via WLAN communications (or other P2P communications, e.g., Bluetooth). Additionally, two STAs may communicate via a direct communication link 110 regardless of whether both STAs are associated with and served by the same AP. In such an ad hoc system, one or more of the STAs may assume the role filled by the AP in a BSS. Such a STA may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections. In some cases, the first wireless device 102 may be capable of communicating with multiple peers including STA(s) and/or AP(s).

The APs and STAs may function and communicate (via the respective communication links 110) according to one or more of the IEEE 802.11 family of wireless communication protocol standards. These standards define the WLAN radio and baseband protocols for the physical (PHY) and medium access control (MAC) layers. The APs and STAs transmit and receive wireless communications (hereinafter also referred to as “wireless packets”) to and from one another in the form of PHY protocol data units (PPDUs). The APs and STAs in the wireless communication system 100 may transmit PPDUs over an unlicensed or shared spectrum, which may be a portion of spectrum that includes frequency bands used by WLAN technology, such as the 2.4 GHz band, the 5 GHz band, the 60 GHz band, the 3.6 GHz band, and the 900 MHz band. Some examples of the APs and STAs described herein also may communicate in other frequency bands, such as the 5.9 GHZ and the 6 GHZ bands, which may support both licensed and unlicensed communications. The APs and STAs also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4 GHZ, 5 GHZ or 6 GHZ bands, each of which is divided into multiple 20 MHz channels. As such, these PPDUs are transmitted over a physical channel having a minimum bandwidth of 20 MHZ, but larger channels can be formed through channel bonding. For example, PPDUs may be transmitted over physical channels having bandwidths of 40 MHZ, 80 MHZ, 160 MHZ, or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

In certain cases, the first wireless device 102 may control the transmit power used to emit RF signals in compliance with an RF exposure limit. RF exposure may be expressed in terms of a specific absorption rate (SAR), which measures energy absorption by human tissue per unit mass and may have units of watts per kilogram (W/kg). RF exposure may also be expressed in terms of power density (PD), which measures energy absorption per unit area and may have units of milliwatts per square centimeter (mW/cm2). In some cases, the RF exposure may be expressed in terms of a specific energy absorption (SA) limit or an absorbed energy density (Uab) limit, for example, for a total RF energy limit allowed in a specific time period. In certain cases, a maximum permissible exposure (MPE) limit in terms of PD may be imposed for wireless communication devices using transmission frequencies above 6 GHZ. Frequency bands of 24 GHz to 71 GHz or greater are sometimes referred to as a “millimeter wave” (“mmW” or “mmWave”). The MPE limit is a regulatory metric for exposure based on area, e.g., an energy density limit defined as a number, X, watts per square meter (W/m²) averaged over a defined area and time-averaged over a frequency-dependent time window in order to prevent a human exposure hazard represented by a tissue temperature change. Certain RF exposure limits may be specified based on a maximum RF exposure metric (e.g., SAR or PD) averaged over a specified time window (e.g., 100 or 360 seconds for sub-6 GHz frequency bands or 2 seconds for 60 GHz bands).

SAR may be used to assess RF exposure for transmission frequencies less than 6 GHz, which cover wireless communication technologies such as 2G/3G (e.g., CDMA), 4G (e.g., E-UTRA), 5G (e.g., NR in sub-6 GHz bands), IEEE 802.11 (e.g., a/b/g/n/ac), etc. PD may be used to assess RF exposure for transmission frequencies higher than 6 GHz, which cover wireless communication technologies such as IEEE 802.11ad, 802.11ay, 5G in mmWave bands, etc. Thus, different metrics may be used to assess RF exposure for different wireless communication technologies.

A wireless device (e.g., the first wireless device 102) may be capable of transmitting signals using multiple wireless communication technologies and/or frequency bands, and in some cases, capable of simultaneous transmission of such signals. For example, the wireless device may transmit signals using a first wireless communication technology operating at or below 6 GHZ (e.g., 3G, 4G, 5G, 802.11a/b/g/n/ac, etc.) and a second wireless communication technology operating above 6 GHz (e.g., mmWave 5G in 24 to 60 GHz bands, IEEE 802.11ad or 802.11ay). In certain aspects, the wireless device may transmit signals using the first wireless communication technology (e.g., 3G, 4G, 5G in sub-6 GHz bands, IEEE 802.11ac, etc.) in which RF exposure may be measured in terms of SAR, and the second wireless communication technology (e.g., 5G in 24 to 71 GHz bands, IEEE 802.11ad, 802.11ay, etc.) in which RF exposure may be measured in terms of PD.

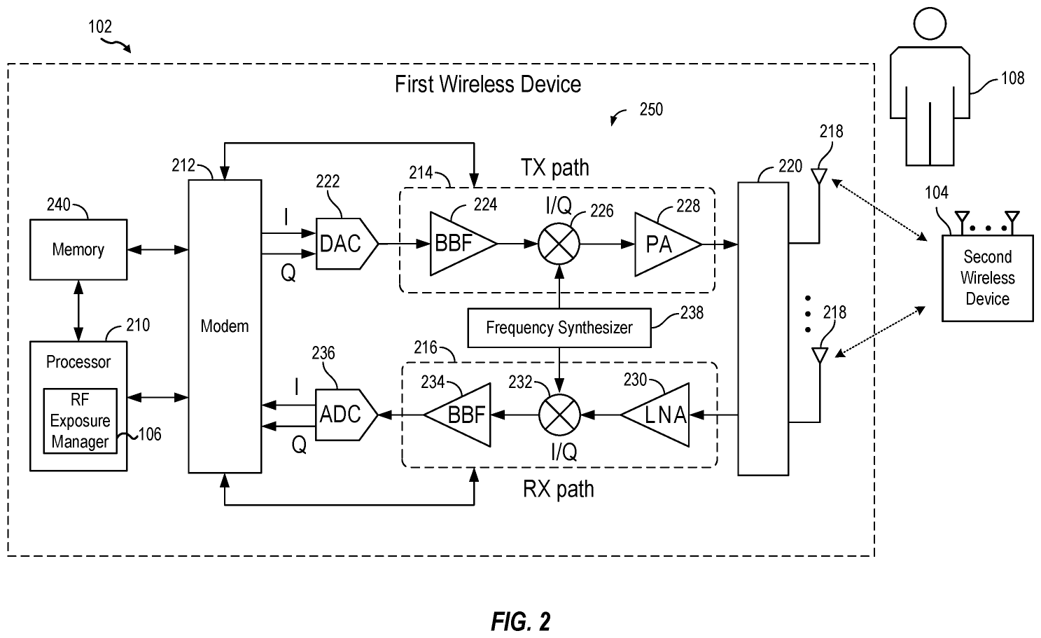

FIG. 2 illustrates example components of the first wireless device 102, which may be used to communicate with any of the second wireless devices 104, in some cases, in proximity to human tissue as represented by the human 108.

The first wireless device 102 may be, or may include, a chip, system on chip (SoC), chipset, package or device that includes one or more modems 212. In some cases, the modem(s) 212 may include, for example, any of a WWAN modem (e.g., a modem configured to communicate via E-UTRA and/or 5G NR standards), a WLAN modem (e.g., a modem configured to communicate via 802.11 standards), a Bluetooth modem, a NTN modem, etc. In certain aspects, the first wireless device 102 also includes one or more radios (collectively “the radio 250”). In some aspects, the first wireless device 102 further includes one or more processors, processing blocks or processing elements (collectively “the processor 210”) and one or more memory blocks or elements (collectively “the memory 240”).

In certain aspects, the processor 210 may include a processor representative of an application processor that generates information (e.g., application data such as content requests) for transmission and/or receives information (e.g., requested content) via the modem 212. In some cases, the processor 210 may include a microprocessor associated with the modem 212, which may implement the RF exposure manager 106 and/or process any of certain protocol stack layers associated with a radio access technology (RAT). For example, the processor 210 may process any of an application layer, packet layer, WLAN protocol stack layers (e.g., a link or MAC layer), and/or WWAN protocol stack layers (e.g., a radio resource control (RRC) layer, a packet data convergence protocol (PDCP) layer, a radio link control (RLC) layer, and a MAC layer). In some cases, at least one of the modems 212 (e.g., the WWAN modem) may be in communication with one or more of the other modems 212 (e.g., the WLAN modem and/or Bluetooth modem). For example, the processor 210 may be representative of at least one of the modems 212 in communication with one or more of the other modems 212.

The modem 212 may include an intelligent hardware block or device such as, for example, an application-specific integrated circuit (ASIC) among other possibilities. The modem 212 may generally be configured to implement a physical (PHY) layer. For example, the modem 212 may be configured to modulate packets and to output the modulated packets to the radio 250 for transmission over a wireless medium. The modem 212 is similarly configured to obtain modulated packets received by the radio 250 and to demodulate the packets to provide demodulated packets. In addition to a modulator and a demodulator, the modem 212 may further include digital signal processing (DSP) circuitry, automatic gain control (AGC), a coder, a decoder, a multiplexer and a demultiplexer (not shown).

As an example, while in a transmission mode, the modem 212 may obtain data from the processor 210. The data obtained from the processor 210 may be provided to a coder, which encodes the data to provide encoded bits. The encoded bits may be mapped to points in a modulation constellation (e.g., using a selected modulation and coding scheme) to provide modulated symbols. The modulated symbols may be mapped, for example, to spatial stream(s) or space-time streams. The modulated symbols may be multiplexed, transformed via an inverse fast Fourier transform (IFFT) block, and subsequently provided to DSP circuitry for transmit windowing and filtering. The digital signals may be provided to a digital-to-analog converter (DAC) 222. In certain aspects involving beamforming, the modulated symbols in the respective spatial streams may be precoded via a steering matrix prior to provision to the IFFT block.

The modem 212 may be coupled to the radio 250 including a transmit (TX) path 214 (also known as a transmit chain) for transmitting signals via one or more antennas 218 and a receive (RX) path 216 (also known as a receive chain) for receiving signals via the antennas 218. When the TX path 214 and the RX path 216 share an antenna 218, the paths may be connected with the antenna via an interface 220, which may include any of various suitable RF devices, such as a switch, a duplexer, a diplexer, a multiplexer, and the like. As an example, the modem 212 may output digital in-phase (I) and/or quadrature (Q) baseband signals representative of the respective symbols to the DAC 222.

Receiving I or Q baseband analog signals from the DAC 222, the TX path 214 may include a baseband filter (BBF) 224, a mixer 226 (which may include one or several mixers), and a power amplifier (PA) 228. The BBF 224 filters the baseband signals received from the DAC 222, and the mixer 226 mixes the filtered baseband signals with a transmit local oscillator (LO) signal to convert the baseband signal to a different frequency (e.g., upconvert from baseband to a radio frequency). In some aspects, the frequency conversion process produces the sum and difference frequencies between the LO frequency and the frequencies of the baseband signal. The sum and difference frequencies are referred to as the beat frequencies. Some beat frequencies are in the RF range, such that the signals output by the mixer 314 are typically RF signals, which may be amplified by the PA 228 before transmission by the antenna 218. The antennas 218 may emit RF signals, which may be received at the second wireless device 104. While one mixer 226 is illustrated, several mixers may be used to upconvert the filtered baseband signals to one or more intermediate frequencies and to thereafter upconvert the intermediate frequency signals to a frequency for transmission.

The RX path 216 may include a low noise amplifier (LNA) 230, a mixer 232 (which may include one or several mixers), and a baseband filter (BBF) 234. RF signals received via the antenna 218 (e.g., from the second wireless device 104) may be amplified by the LNA 230, and the mixer 232 mixes the amplified RF signals with a receive local oscillator (LO) signal to convert the RF signal to a baseband frequency (e.g., downconvert). The baseband signals output by the mixer 232 may be filtered by the BBF 234 before being converted by an analog-to-digital converter (ADC) 236 to digital I or Q signals for digital signal processing. The modem 212 may receive the digital I or Q signals and further process the digital signals, for example, demodulating the digital signals.

Certain transceivers may employ frequency synthesizers with a voltage-controlled oscillator (VCO) to generate a stable, tunable LO frequency with a particular tuning range. Thus, the transmit LO frequency may be produced by a frequency synthesizer 238, which may be buffered or amplified by an amplifier (not shown) before being mixed with the baseband signals in the mixer 226. Similarly, the receive LO frequency may be produced by the frequency synthesizer 238, which may be buffered or amplified by an amplifier (not shown) before being mixed with the RF signals in the mixer 232. Separate frequency synthesizers may be used for the TX path 214 and the RX path 216.

While in a reception mode, the modem 212 may obtain digitally converted signals via the ADC 236 and RX path 216. As an example, in the modem 212, digital signals may be provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may be fed to the AGC, which is configured to use information extracted from the digital signals, for example, in one or more received training fields, to determine an appropriate gain. The output of the DSP circuitry also may be coupled with the demodulator, which is configured to extract modulated symbols from the signal and, for example, compute the logarithm likelihood ratios (LLRs) for each bit position of each subcarrier in each spatial stream. The demodulator may be coupled with the decoder, which may be configured to process the LLRs to provide decoded bits. The decoded bits from all of the spatial streams may be fed to the demultiplexer for demultiplexing. The demultiplexed bits may be descrambled and provided to a medium access control layer (e.g., the processor 210) for processing, evaluation, or interpretation.

The processor 210 and/or modem 212 may control the transmission of signals via the TX path 214 and/or reception of signals via the RX path 216. In some aspects, the processor 210 and/or modem 212 may be configured to perform various operations, such as those associated with any of the methods described herein. The processor 210 and/or the modem 212 may include a microcontroller, a microprocessor, an application processor, a baseband processor, a MAC processor, a neural network processor, a digital signal processor (DSP), an application specific integrated circuit (ASIC), a field programmable gate array (FPGA) or other programmable logic device (PLD), discrete gate or transistor logic, discrete hardware components, or any combination thereof. In some cases, aspects of the processor 210 may be integrated with (incorporated in and/or shared with) the modem 212, such as the RF exposure manager 106, a microcontroller, a microprocessor, a baseband processor, a medium access control (MAC) processor, a digital signal processor, etc. For example, the processor 210 may be representative of a co-processor (e.g., a microprocessor) associated with the modem 212, and the modem 212 may be representative of an ASIC including the baseband processor, MAC processor, DSP, and/or neural network processor. The memory 240 may store data and program codes (e.g., computer-readable instructions) for performing wireless communications as described herein. The memory 240 may be external to the processor 210 and/or the modem 212 (as illustrated) and/or incorporated therein. In certain cases, the RF exposure manager 106 (as implemented via the processor 210 and/or modem 212) may determine a transmit power (e.g., corresponding to certain levels of gain(s) applied to the TX path 214 including the BBF 224, the mixer 226, and/or the PA 228) that complies with an RF exposure limit set by country-specific regulations and/or international guidelines (e.g., International Commission on Non-Ionizing Radiation Protection (ICNIRP) guidelines) as described herein.

FIG. 2 shows an example transceiver design. It will be appreciated that other transceiver designs or architectures may be applied in connection with aspects of the present disclosure. For example, while examples discussed herein utilize I and Q signals (e.g., quadrature modulation), those of skill in the art will understand that components of the transceiver may be configured to utilize any other suitable modulation, such as polar modulation. As another example, circuit blocks may be arranged differently from the configuration shown in FIG. 2, and/or other circuit blocks not shown in FIG. 2 may be implemented in addition to or instead of the blocks depicted.

In certain cases, compliance with an RF exposure limit may be performed as a time-averaged RF exposure evaluation within a specified running (moving) time window associated with the RF exposure limit. The RF exposure limit may specify a time-averaged RF exposure metric (e.g., SAR and/or PD) over the running time window. As an example, the Federal Communications Commission (FCC) specifies that certain SAR limits (general public exposure) are 0.08 W/kg, as averaged over the whole body, and a peak spatial-average SAR of 1.6 W/kg, averaged over any 1 gram of tissue (defined as a tissue volume in the shape of a cube) for sub-6 GHz bands, whereas certain PD limits are 1 mW/cm2, as averaged over the whole body, and a peak spatial-average PD of 4 mW/cm2, averaged over any 1 cm2. The FCC also specifies the corresponding averaging time may be six minutes (360 seconds) for sub-6 GHz bands, whereas the averaging time may be 2 seconds for mm Wave bands (e.g., 60 GHz frequency bands) under a proposed regulation, for example.

The RF exposure limit and/or corresponding averaging time window may vary based on the frequency band. In certain aspects, the RF exposure limit(s) and/or corresponding averaging time window(s), if applicable, may be specific to a particular geographic region or country, such as the United States, Canada, China, or European Union. In some cases, the RF exposure limit(s) may specify the maximum allowed RF exposure that can be encountered without time averaging. In such cases, the maximum allowed RF exposure may correspond to a maximum output or transmit power that can be used by the wireless device.

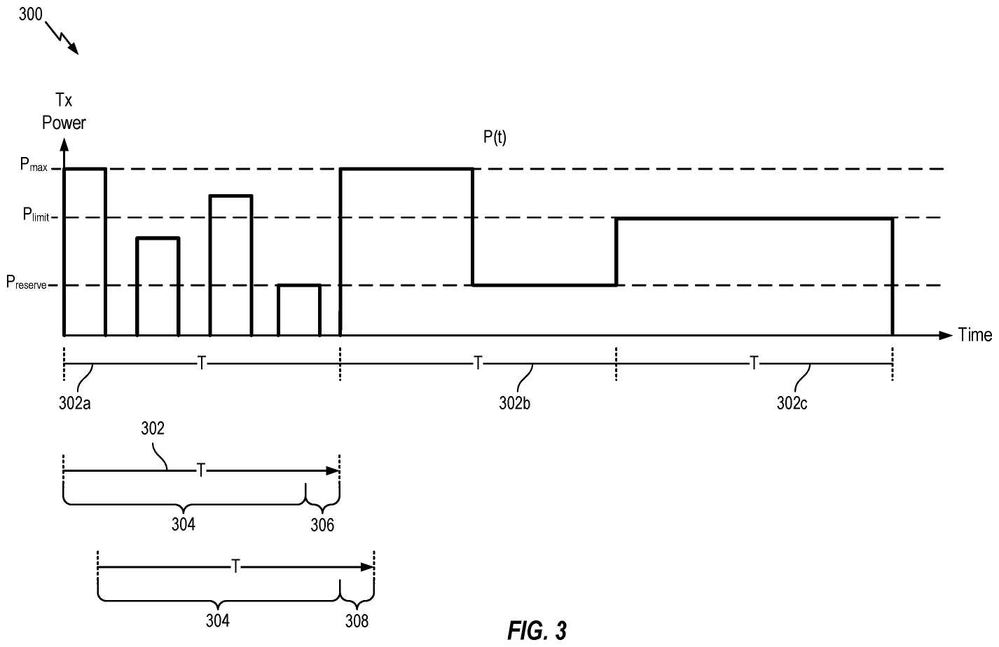

FIG. 3 is a graph 300 of a transmit power over time (P(t)) that varies over a running (e.g., rolling or moving) time window (T) associated with the RF exposure limit. The wireless device (e.g., the first wireless device 102) may evaluate RF exposure compliance over the running time window 302 (T) based on past RF exposure (e.g., a transmit power report) in a past time interval 304 of the time window 302 and a future time interval 306. The wireless device may determine the maximum allowed transmit power for the future time interval 306 that satisfies the time-averaged RF exposure limit based on the past RF exposure used in the past time interval 304. The wireless device may perform such a time-averaging evaluation as the time window 302 moves over time, for example, in the next future time interval 308, where the past time interval 304 now includes the previous future time interval 306.

The maximum time-averaged transmit power limit (Pₗᵢₘᵢₜ) represents the maximum transmit power the wireless device can transmit continuously for the duration of the running time window 302 (T) in compliance with the RF exposure limit. For example, the wireless device is transmitting continuously at Pₗᵢₘᵢₜ in the third time window 302c such that the time-averaged transmit power over the time window (e.g., the third time window 302c) is equal to Pₗᵢₘᵢₜ in compliance with the time-averaged RF exposure limit.

In certain cases, an instantaneous transmit power may exceed Pₗᵢₘᵢₜ in certain transmission occasions, for example, as shown in the first time window 302a and the second time window 302b. In some cases, the wireless device may transmit at Pₘₐₓ, which may be the maximum instantaneous transmit power supported by the wireless device, the maximum instantaneous transmit power the wireless device is capable of outputting, or the maximum instantaneous transmit power allowed by a standard or regulatory body (e.g., the maximum output power, PCMAX). In some cases, the wireless device may transmit at a transmit power less than or equal to Pₗᵢₘᵢₜ in certain transmission occasions, for example, as shown in the first time window 302a.

In certain cases, a reserve power may be used to enable a continuous transmission within a time window (T) when transmitting above Pₗᵢₘᵢₜ in the time window or to enable a certain level of quality for certain transmissions. As shown in the second time window 302b, the transmit power may be backed off from Pₘₐₓ to a reserve power (Pᵣₑₛₑᵣᵥₑ) so that the wireless device can maintain a continuous transmission during the time window (e.g., maintain a radio connection with a receiving entity) in compliance with the time-averaged RF exposure limit. In the third time window 302c, the wireless device may increase the transmit power to Pₗᵢₘᵢₜ in compliance with the time-averaged RF exposure limit. In some cases, Pᵣₑₛₑᵣᵥₑ may allow for a certain level of transmission quality for certain transmissions (e.g., control signaling), high priority communications, low latency communications, highly reliable communications, etc.). Pᵣₑₛₑᵣᵥₑ may be used to reserve transmit power for at least a portion of the time window 302 for certain transmissions (e.g., control signaling).

In the second time window 302b, the area between Pₘₐₓ and Pᵣₑₛₑᵣᵥₑ for the time duration of transmitting at Pₘₐₓ may be equal to the area between Pₗᵢₘᵢₜ and Pᵣₑₛₑᵣᵥₑ for the time window T, such that the total area of transmit power (P(t)) in the second time window 302b is equal to the area of Pₗᵢₘᵢₜ for the time window T. Such an area may be considered using 100% of the energy (transmit power or exposure) to remain compliant with the time-averaged RF exposure limit. Without the reserve power Pᵣₑₛₑᵣᵥₑ, the transmitter may transmit at Pₘₐₓ for a portion of the time window with the transmitter turned off for the remainder of the time window to ensure compliance with the time-averaged RF exposure limit.

In some aspects, the wireless device may transmit at a power that is higher than Pₗᵢₘᵢₜ, but less than Pₘₐₓ in the time-average mode illustrated in the second time window 302b. While a single transmit burst is illustrated in the second time window 302b, it will be understood that the wireless device may instead utilize a plurality of transmit bursts within the time window (T), where the transmit bursts are separated by periods during which the transmit power is maintained at or below Pᵣₑₛₑᵣᵥₑ. Further, it will be understood that the transmit power of each transmit burst may vary (either within the burst and/or in comparison to other bursts), and that at least a portion of the burst may be transmitted at a power above Pₗᵢₘᵢₜ.

In certain aspects, the wireless device may transmit at a power less than or equal to a fixed power limit (e.g., Pₗᵢₘᵢₜ) without considering past exposure and/or past transmit powers in terms of a time-averaged RF exposure. For example, the wireless device may transmit at a power less than or equal to Pₗᵢₘᵢₜ using a look-up table (comprising one or more values of Pₗᵢₘᵢₜ depending on an RF exposure scenario). The look-up table may provide one or more values of Pₗᵢₘᵢₜ depending on the transmit frequency, transmit antenna, radio configuration (single-radio or multi-radio) and/or RF exposure scenario (e.g., a device state index corresponding to head exposure, body or torso exposure, extremity or hand exposure, and/or hotspot exposure) encountered by the wireless device. Examples of RF exposure scenarios include cases where the wireless device is emitting RF signals proximate to human tissue, such as a user's head, hand, or body (e.g., torso), or where the wireless device is being used as a hotspot away from human tissue. Therefore, the RF exposure can be managed as a time-averaged RF exposure evaluation (e.g., illustrated in FIG. 3), managed using a look-up table or flat or maximum value, or using another strategy or algorithm, where a particular process of managing the RF exposure may be referred to herein as an RF exposure control scheme.

For certain aspects, a wireless device may exhibit or be configured with a transmission duty cycle. The wireless device may determine transmit power level(s) and/or reserve power level(s) in compliance with the time-averaged RF exposure limit based on the duty cycle. The transmission duty cycle may be indicative of a share (e.g., 100 ms) of a specific period (e.g., 500 ms) in which the wireless device transmits RF signals. The duty cycle may be a ratio of the share to the specific period (e.g., 100 ms/500 ms), where the duty cycle may be represented as a number from zero to one. The duty cycle may be an effective duty cycle associated with a total transmit time of one or more transmissions in the time period, where the one or more transmissions may include bursts of transmissions having a gap of time positioned between at least two of the bursts. For example, in the first time window 302a, the duty cycle may be greater than 50% of the duration of the time window (T), whereas in the second time window 302b, the duty cycle may be equal to 100% of the duration of the time window (T). In certain cases, the duty cycle may be standardized (e.g., predetermined) with a specific RAT and/or vary over time, for example, due to changes in radio conditions, mobility, and/or user behavior. As an example, certain RATs may specify the uplink duty cycle in the form of a time division duplexing (TDD) configuration, such as a TDD uplink-downlink (UL-DL) slot pattern in 5G NR or similar TDD patterns in E-UTRA or UMTS. In 5G NR, the TDD UL-DL slot pattern may specify the number of uplink slots and corresponding position in time associated with the uplink slots in a sequence of slots, such that the total number of uplink slots with respect to the total number of slots in the sequence is indicative of the duty cycle. In certain aspects, the duty cycle may correspond to the actual duration for past transmissions scheduled or used, for example, within the TDD UL-DL slot pattern. For example, although the wireless device may be configured with a TDD UL-DL slot pattern, the wireless device may use a portion or subset of the UL slots for transmitting RF signals. Thus, the duty cycle for the wireless device may be less than the maximum available duty cycle corresponding to the TDD UL-DL slot pattern.

Some wireless communication devices (including both APs and STAs) are capable of multi-link operation (MLO). In some examples, MLO supports establishing multiple different communication links (such as a first link on a 2.4 GHz band, a second link on a 5 GHz band, and a third link on a 6 GHz band) between the STA and the AP. Each communication link may support one or more sets of channels or logical entities. In some cases, each communication link associated with a given wireless communication device may be associated with a respective radio of the wireless communication device, which may include one or more transmit/receive (Tx/Rx) chains, include or be coupled with one or more physical antennas, or include signal processing components, among other components. An MLO-capable device may be referred to as a multi-link device (MLD). For example, an AP MLD may include multiple APs each configured to communicate on a respective communication link with a respective one of multiple STAs of a non-AP MLD (also referred to as a “STA MLD”). The STA MLD may communicate with the AP MLD over one or more of the multiple communication links at a given time.

One type of MLO is multi-link aggregation (MLA), where traffic associated with a single STA is simultaneously transmitted across multiple communication links in parallel to maximize the utilization of available resources to achieve higher throughput. That is, during at least some duration of time, transmissions or portions of transmissions may occur over two or more links in parallel at the same time. In some examples, the parallel wireless communication links may support synchronized transmissions. In some other examples, or during some other durations of time, transmissions over the links may be parallel, but not be synchronized or concurrent. In some examples or durations of time, two or more of the links may be used for communications between the wireless communication devices in the same direction (such as all uplink or all downlink). In some other examples or durations of time, two or more of the links may be used for communications in different directions. For example, one or more links may support uplink communications and one or more links may support downlink communications. In such examples, at least one of the wireless communication devices operates in a full duplex mode. Generally, full duplex operation enables bi-directional communications where at least one of the wireless communication devices may transmit and receive at the same time.

MLA may be implemented in a number of ways. In some examples, MLA may be packet-based. For packet-based aggregation, frames of a single traffic flow (such as all traffic associated with a given traffic identifier (TID)) may be sent concurrently across multiple communication links. In some other examples, MLA may be flow-based. For flow-based aggregation, each traffic flow (such as all traffic associated with a given TID) may be sent using a single one of multiple available communication links. As an example, a single STA MLD may access a web browser while streaming a video in parallel. The traffic associated with the web browser access may be communicated over a first communication link while the traffic associated with the video stream may be communicated over a second communication link in parallel (such that at least some of the data may be transmitted on the first channel concurrently with data transmitted on the second channel).

In some other examples, MLA may be implemented as a hybrid of flow-based and packet-based aggregation. For example, an MLD may employ flow-based aggregation in situations in which multiple traffic flows are created and may employ packet-based aggregation in other situations. The determination to switch among the MLA techniques or modes may additionally or alternatively be associated with other metrics (such as a time of day, traffic load within the network, or battery power for a wireless communication device, among other factors or considerations).

To support MLO techniques, an AP MLD and a STA MLD may exchange supported MLO capability information (such as supported aggregation type or supported frequency bands, among other information). In some examples, the exchange of information may occur via a beacon signal, a probe request or probe response, an association request or an association response frame, a dedicated action frame, or an operating mode indicator (OMI), among other examples. In some examples, an AP MLD may designate a given channel in a given band as an anchor channel (such as the channel on which it transmits beacons and other management frames). In such examples, the AP MLD also may transmit beacons (such as ones which may contain less information) on other channels for discovery purposes.

MLO techniques may provide multiple benefits to a WLAN. For example MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless communication device in terms of power consumption. Another benefit of MLO is the increased multiplexing opportunities in the case of a single BSS. For example, multi-link aggregation may increase the number of users per multiplexed transmission served by the multi-link AP MLD.

In certain wireless communication networks (e.g., 802.11be networks), a MLD may be a wireless communication device with multiple affiliated APs or STAs. The MLD may have a single medium access control (MAC) service access point (SAP) to a logical link control (LLC) layer. The MLD may also have a MAC address that uniquely identifies the MLD management entity. An MLD may support various multi-link operations (MLOs). In some aspects, MLO may include multi-band aggregation, where two or more channels at different bands (e.g., 2.4, 5, and 6 GHz bands) are combined to achieve higher transmission rates. In some aspects, the 6 GHz band may include a frequency range of 5.925-7.125 GHz. For example, a frame (or data) may be segmented and transmitted simultaneously through the different channels in the different bands, reducing the frame's transmission time or facilitating transmission of a larger aggregated frame. MLO may include multi-band and multi-channel full duplex communications, which is achieved through transmitting and receiving on different channels (in the same or different bands) at the same time. MLO may include data and control plane separation on to different channels (in the same or different bands). In certain aspects, MLO may be implemented with a multi-link single radio (MLSR) architecture, where the multiple affiliated APs or STAs of an MLD may be logical devices associated with a single radio.

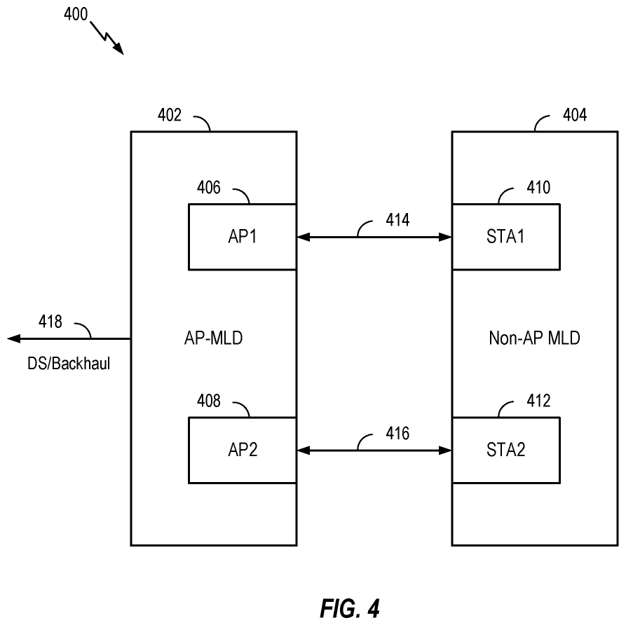

FIG. 4 is a block diagram illustrating an example multi-link operation between MLDs. As shown, an AP MLD 402 may communicate with a non-AP MLD 404 via multi-link communications, such as multi-band aggregation. The first wireless device 102 may include the AP MLD 402 or the non-AP MLD 404. The AP MLD 402 may also be in communication with other systems (e.g., a distribution system (DS) such as a local area network and/or a wide area network) via an interface 418, such as a wired or wireless backhaul interface. The AP MLD 402 may include at least two STA entities 406, 408 (sometimes referred to as STA instances and also referred to herein simply as STAs) that may communicate with associated STA entities 410, 412 of the non-AP MLD 404. A STA entity (or instance) of an AP MLD are generally APs (which may be referred to as AP-STAs or STAs serving as APs), and a STA entity of a non-AP MLD are generally non-AP STAs (which may be referred to simply as a STA). MLDs may use multi-link operations, such as multi-link aggregation (MLA) (which includes packet level aggregation), where MAC protocol data units (MPDUs) from a same traffic ID (TID) can be sent via two or more links 414, 416.

In aspects, each of the STA entities 406, 408 may communicate on separate bands (e.g., a 2.4 GHz band, a 5 GHz band, and/or a 6 GHz band), and similarly, each of the STA entities 410, 412 may communicate on separate bands. For example, the STA entities 406, 410 may communicate with each other on a first link 414 via a first band (e.g., 5 GHz band), and the STA entities 408, 412 may communicate with each other on a second link 416 via a second band (e.g., 6 GHz band). The aggregated links 414, 416 may enable desirable throughputs and latencies between the AP MLD 402 and the non-AP MLD 404. In some aspects, the STA entities (406, 408 or 410, 412) of an MLD may be implemented as separate devices or RF transceiver chips of the MLD, or the STA entities may be integrated into the same device or RF transceiver chip. In certain aspects, a link may refer to a physical path having one traversal of the wireless medium (WM) that is usable to transfer various packets, messages, or frames (such as MAC service data units (MSDUs)) between two stations (STAs).

As described herein, an IL associated with one or more radios (e.g., WWAN radio(s)) may not distinguish between multiple concurrent connections (e.g., connections corresponding to multiple links and/or multiple peers in a WWAN) when allocating transmit powers to such connections. The IL may not consider certain characteristics associated with the connections in determining the transmit powers for the connections. For example, the wireless device may not consider the transmission distance associated with each of the connections in determining the transmit powers. As an example, the wireless device may allocate the same transmit powers to peers that are the closest to and farthest from the wireless device. As such, the transmit power budget may not be efficiently distributed among the connections, which may result in reduced performance for some connections.

### Example Multi-Connection RF Exposure Compliance

Aspects of the present disclosure provide apparatus and methods for multi-connection RF exposure compliance. A wireless device may distribute a transmit power budget among multiple connections on a per-connection basis considering one or more characteristics associated with the connections. For example, the wireless device may allocate separate transmit powers for the connections based on a distance to each of the peers associated with the connections. The characteristics may include, for example, a signal strength, a data error rate, a round-trip time, a duty cycle, etc. The connections may be associated with WLAN communications, such as multiple links in MLO/MLA and/or multiple peers (including STA(s) and/or AP(s)). In some examples, the transmit power budget may be distributed among the connections using a constrained optimization method, such as a Lagrange multiplier.

The apparatus and methods for multi-connection RF exposure compliance described herein may provide various advantages. For example, the multi-connection aware RF exposure compliance may improve wireless communication performance, including, for example, an increased throughput, decreased latency, and/or increased transmission range, where the improved performance may be attributable to efficient distribution of transmit powers to multiple connections. For example, the wireless device may distribute a smaller share of a transmit power budget to a peer that is closer to the wireless device and a larger share of the transmit power budget to another peer that is farther from the wireless device. Such a distribution of the transmit power budget may allow the wireless device to communicate with both peers with increased throughput, decreased latency, and/or at an increased transmission range (e.g., for the peer that is farthest from the wireless device).

Some example scenarios that involve multiple connections, which may apply the multi-connection aware exposure compliance as described herein, may include, a service access point (SAP) with links to multiple STAs; a neighbor awareness network (NAN)-Wi-Fi Aware-including NAN 1:N or N:1; peer-to-peer communications (e.g., Wi-Fi Direct) including group owner (GO) and/or group client (GC) in 1:N or N:1 scenario; any other multi-channel concurrency (MCC) and/or single-channel concurrency (SCC) scenario, for example, including SAP/STA, P2P/STA, NAN/STA, etc.; MLO and/or MLSR; or any combination thereof.

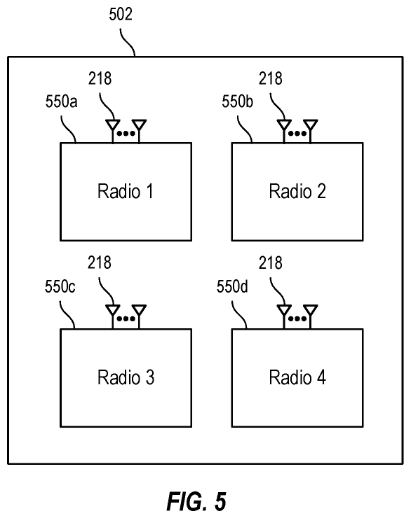

FIG. 5 is a diagram illustrating an example wireless device 502 (e.g., the first wireless device 102) having multiple radios 550a-d (e.g., the radios 250). In this example, the radios 550a-d may be associated with any of various RATs and/or frequency bands, channels, bandwidths, carriers, etc. For example, the first radio 550a may communicate via WWAN RAT(s) (e.g., E-UTRA and/or 5G NR) in sub-6 GHz frequency bands. The second radio 550b may communicate via WWAN RAT(s) (e.g., 5G NR) in mmWave frequency bands. The third radio 550c may communicate via WLAN RAT(s) in sub-6 GHz (e.g., 2.4 GHZ, 5 GHZ, and/or 6 GHZ) frequency bands. The fourth radio 550d may communicate via short-range communications (e.g., Bluetooth) in a 2.4 GHz frequency band. While this example shows a wireless device having four radios, a wireless device may have any number of radios for wireless communications, such as a radio per one or more frequency bands associated with WWAN and/or WLAN communications, a radio per RAT, and/or a radio capable of communicating via multiple RATs.

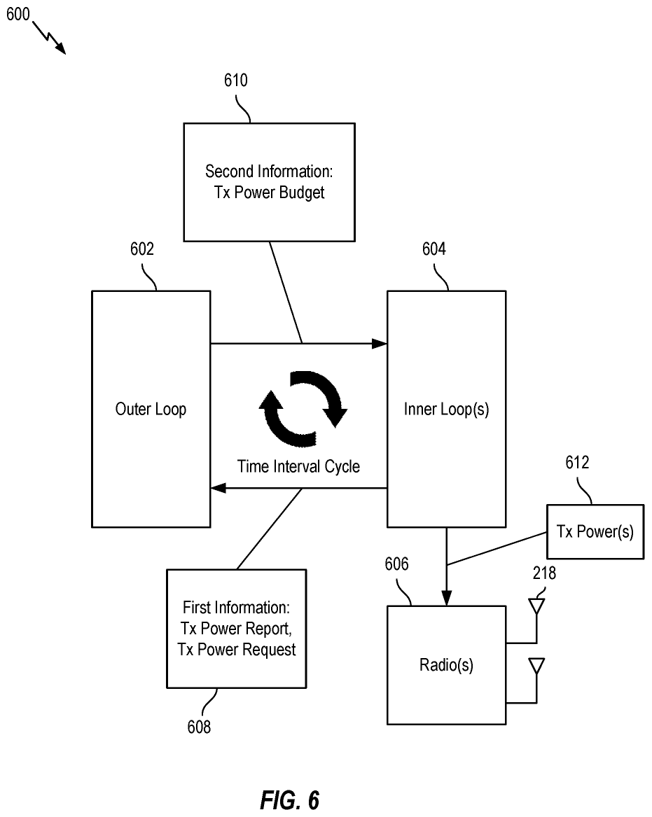

FIG. 6 is a diagram illustrating an example logical architecture 600 for controlling the transmit power (and hence, the RF exposure) associated with one or more radios 606 (e.g., the radio(s) 550a-d) of a wireless device (e.g., the wireless device 502). As the outer loop 602 and the inner loop(s) 604 control transmit power(s) applied at the radio(s) 606 to be in compliance with an RF exposure limit, aspects of the outer loop 602 and/or the inner loop(s) 604 may be representative of the RF exposure manager 106. In certain aspects, the outer loop 602 may be representative of a centralized RF exposure manager, and the inner loop(s) may be representative of transmit power manager(s) associated with the radio(s) 606, as further described herein. As an example, the outer loop 602 may be implemented in a WWAN modem, and at least one of the inner loops 604 may be implemented in a WLAN modem or a multi-RAT modem (e.g., WLAN and Bluetooth). With respect to FIG. 2, the outer loop 602 may be implemented in the processor 210 (which as described herein may include or be representative of, in some cases, a modem—e.g., a WWAN modem), and the inner loop 604 may be implemented in the modem 212—e.g., another modem, such as a WLAN modem.

In this example, the outer loop 602 operates as a centralized controller for controlling the RF exposure associated with the radios 606. The outer loop 602 may determine the maximum allowed transmit powers that can be used for a future time interval based on the past transmit powers associated with all (or some) of the radios 606. For example, the outer loop 602 may periodically (e.g., every 500 milliseconds) receive first information 608 from the inner loop(s) 604 associated with the radios 606. In some cases, the outer loop 602 may obtain the first information 608 in response to certain criteria (e.g., a triggering event including a change in channel conditions, quality of service, etc.). The periodicity in which the first information 608 is obtained at the outer loop 602 may correspond to a time interval cycle, such as following each future time interval 306, 308 of the rolling time window 302.

The first information 608 may include an indication of a transmit power report and/or an indication of a transmit power request associated with a respective inner loop 604. The indication of the transmit power request may include a requested transmit power or exposure margin for a future time interval (e.g., the time interval 306, 308). The indication of the transmit power report may include past transmit power history or an average transmit power associated with a time interval (e.g., a past time interval in a rolling time window, such as the past time interval 304 or the previous future time interval). A particular inner loop 604 may be associated with one or more radios (e.g., any of the radios 550a-d), and thus, the first information 608 may be associated with such radio(s). As an example, at least one of the inner loops 604 may provide the first information 608 associated with a WLAN radio to the outer loop 602.

The outer loop 602 may determine separate transmit power budgets for the inner loops 604, for example, based on the first information 608 and/or other information (e.g., a particular transmit power budget allocation for an inner loop). In some aspects, the outer loop 602 may determine the transmit power budgets without the first information 608, for example, when an inner loop 604 is not configured to provide the first information 608. The transmit power budgets may be associated with a time interval, such as the future time interval 306, 308, in which to apply the transmit power budgets. The transmit power budgets for the inner loops 604 may comply with an RF exposure limit. For example, the inner loop(s) 604 may obtain the respective transmit power budgets before the future time interval occurs, and the inner loop(s) 604 may determine particular transmit power(s) to use in compliance with the respective transmit power budget(s).

In certain aspects, the outer loop 602 may periodically provide second information 610 to the inner loop(s) 604, where the second information 610 may indicate the transmit power budgets associated with the inner loops 604. In some cases, each of the inner loops 604 may obtain the second information 610, which may indicate a portion of the total transmit power budget for each of the inner loops 604. For example, the outer loop 602 may provide a first transmit power budget to a first inner loop and a second transmit power budget to a second inner loop, where the first transmit power budget and the second transmit power budget are portions of the total transmit power budget distributed among the inner loops 604. In certain cases, a subset of the inner loops 604 may be assigned transmit power budgets, for example, when certain radio(s) are disabled (e.g., in an idle mode or sleep mode) and not expected to communicate in the respective time interval. In such cases, the outer loop 602 may provide the second information 610 to only the subset of the inner loops 604.

For certain aspects, the inner loop 604 may operate in a standalone mode, where the inner loop 604 determines its own transmit power budget in compliance with the RF exposure limit. In standalone mode, the inner loop 604 may determine the transmit power budget without periodic updates from the outer loop 602 and/or other inner loops 604. The inner loop 604 may not communicate with the outer loop 602 while operating in standalone mode. As an example, the inner loop 604 may temporarily stop communications with the outer loop 602 due to the outer loop 602 being in an idle mode or sleep mode, and as such, the inner loop 604 may operate in a standalone mode for purposes of determining RF exposure compliant transmit powers. In some cases, the inner loop 604 may permanently operate in a standalone mode without the updates from the outer loop 602. For example, a WLAN modem and/or a Bluetooth modem may operate in a standalone mode separated from an outer loop and/or inner loop associated with WWAN communications. In such cases of standalone mode, obtaining the transmit power budget may involve the inner loop 604 generating the transmit power budget. In some cases, exposure for one or more RATs (e.g., WWAN) may be managed by a first outer loop 602 while one or more other RATs (e.g., WLAN, Bluetooth, and/or NTN) are managed by a second outer loop 602.

A transmit power budget may indicate the maximum allowed time-averaged transmit power that one or more radio(s) can use for the future time interval in compliance with an RF exposure limit. The maximum allowed time-averaged transmit power may correspond to a portion of a rolling time window (e.g., the future time interval), whereas the maximum time-averaged transmit power (e.g., Pₗᵢₘᵢₜ) may correspond to the entire duration of such a time window associated with the RF exposure limit. A total transmit power budget of a wireless device may be shared among multiple RATs, for example, including WWAN, WLAN, NTN, V2X, D2D, and/or short-range (e.g., Bluetooth) communications. In some cases, the total transmit power budget may be allocated to a single RAT.

The inner loop 604 may determine transmit powers on a per-connection basis among a plurality of connections (e.g., link(s) and/or peer(s)) based at least in part on the transmit power budget and one or more characteristics associated with the connections. The inner loop 604 may distribute the transmit power budget among the multiple connections based on the characteristic(s) associated with the connections. The inner loop 604 may provide an indication of transmit power(s) 612 to the radios 606 to be used for transmission(s) in the time interval. The indication of the transmit powers 612 may include a maximum allowed transmit power that can be used for the time interval, where the maximum allowed transmit power is in compliance with the RF exposure limit according to the transmit power budget.

It will be appreciated that other transmit power control(s) may provide an additional or alternative transmit power budget and/or limit the maximum transmit power determined, such as interference or RF emissions limits. In certain aspects, the inner loop 604 may apply any suitable transmit power controls, such as an RF emission limit, interference limit, RF saturation limit, etc., in addition to or instead of the RF exposure-based transmit power budget, where such transmit power control may provide a transmit power budget that may be distributed among the connections as described herein.

As a multi-link example, the inner loop 604 may determine a first transmit power for the first link 414 and a second transmit power for the second link 416 based on characteristic(s) associated with the links 414, 416—such as a duty cycle and/or signal quality associated with each of the links 414, 416. For example, the inner loop 604 may assign more of the transmit power budget (e.g., corresponding to a transmit power over all or some of the time interval) to the first link 414 when the corresponding duty cycle of the first link 414 is larger than the duty cycle of the second link 416. Such a transmit power budget distribution may allow the wireless device to distribute more of the transmit power budget to a link that is transmitting more often than other link(s) as indicated by the duty cycle.

As a multi-peer example, the inner loop 604 may determine a first transmit power for a first peer (e.g., the AP 104e) and a second transmit power for a second peer (e.g., the UE 104f) based on characteristic(s) associated with the peers-such as a round-trip time, signal strength (e.g., received signal strength indication (RSSI)) and/or a data error rate (e.g., packet error rate) associated with each of the peers. For example, the inner loop 604 may assign more of the transmit power budget to the first peer when the first peer has a longer round-trip time than the second peer. Such a transmit power budget distribution may allow the wireless device to transmit at an increased transmit power that adequately overcomes the path loss associated with the first peer.

In a multi-peer/multi-link scenario, the inner loop 604 may determine particular weights for the power allocation for each connection based on any of various characteristics associated with each connection. Examples of the characteristics include received signal strength indication (RSSI), round-trip-time (RTT), packet error rate (PER), channel conditions, duty cycle, and the like. In some cases, the inner loop 604 may determine each of the transmit powers associated with the connections based on the respective weights, for example, as a product of a transmit power (e.g., a maximum allowed transmit power) and a given weight.

For example, consider a three-peer (or a three-link) scenario (1:3), where a wireless communication device is transmitting to three peers, and the RSSI is −75 dBm, −50 dBm, and −25 dBm for the respective peer, for example, in a time interval (e.g., the time interval 306). The weights could be derived such that the device will transmit with the highest transmit power for the peer with the smallest RSSI (−75 dBm), with an intermediate transmit power for the peer with the intermediate RSSI (−50 dBm), and with the smallest transmit power for the peer with the greatest RSSI (−25 dBm).

In certain aspects, the inner loop 604 may apply a constrained optimization method (e.g., a Lagrange multiplier) to determine the transmit powers 612. Assuming there are N links and/or peers, the overall capacity (C)—e.g., throughput—can be determined (or estimated) as a function of the signal-to-noise ratio (SNR) associated with the links/peers:

$$C = {\sum }_{i = 1}^{N} {log}_{2} ( 1 + \frac{{P}_{i}}{{σ}_{n}^{2}} ) \qquad ( 1 )$$

where Pᵢ is the signal power of the i^{th} link/peer, and σₙ² is the noise power. Thus,

$$\frac{{P}_{i}}{{σ}_{n}^{2}}$$

represents the SNR associated with a link/peer.

A power budget constraint may be applied as follows for the signal powers:

$${\sum }_{i = 1}^{N} {w}_{i} {P}_{i} \leq P \qquad ( 2 )$$

where P is the total power budget allocated to all of the links and/or peers, for example, from the outer loop, and wᵢ is the weight for the i^{th} link/peer. The inner loop 604 may determine the weight associated with a connection based on any of the characteristics associated with the connections as described herein, including, for example, a duty cycle, round-trip time, transmission distance, path loss, signal strength, signal quality (e.g., SNR), data error rate or ratio, etc.

Hence, a constrained optimization method can solve this, for example, by using a Lagrange multiplier. In this case, the cost function (F) may be determined as:

$$F = {\sum }_{i = 1}^{N} {log}_{2} ( 1 + \frac{{P}_{i}}{{σ}_{n}^{2}} ) + λ ( P - {\sum }_{i = 1}^{N} {w}_{i} {P}_{i} ) \qquad ( 3 )$$

where λ is the Lagrange multiplier.

Upon solving, the individual signal power (Pᵢ) associated with a link/peer may be determined with respect to the Lagrange multiple as:

$${P}_{i} = \frac{1}{λ {w}_{i}} - {σ}_{n}^{2} \qquad ( 4 )$$

The Lagrange multiplier (λ) can, thus, be solved using the equation:

$$P = {\sum }_{i = 1}^{N} {w}_{i} ( \frac{1}{λ {w}_{i}} - {σ}_{n}^{2} ) \qquad ( 5 )$$

The constrained optimization method (e.g., with the Lagrange multiplier) may allow the wireless device to efficiently distribute the transmit power budget among multiple connections. It will be appreciated that any suitable characteristic associated with the connections (links/peers) may be applied to the constrained optimization method. For example, the capacity may be estimated with any suitable characteristic, including, for example, a data error rate, round-trip time, duty cycle, path loss, signal strength (e.g., RSSI), signal quality (e.g., SNR), etc.

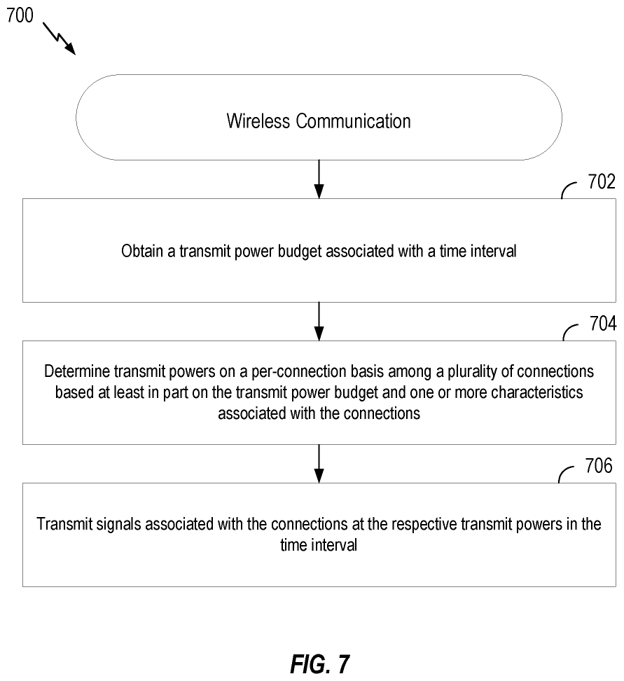

FIG. 7 is a flow diagram illustrating example operations 700 for wireless communication. The operations 700 may be performed, for example, by a wireless device (e.g., the first wireless device 102 in the wireless communication system 100). The operations 700 may be implemented as software components that are executed and run on one or more processors (e.g., the processor 210 and/or the modem 212 of FIG. 2). Further, the transmission and/or reception of signals by the wireless device in the operations 700 may be enabled, for example, by one or more antennas (e.g., antennas 218 of FIG. 2). In certain aspects, the transmission and/or reception of signals by the wireless device may be implemented via a bus interface of one or more processors (e.g., the processor 210 and/or the modem 212) obtaining and/or outputting signals for reception or transmission.

The operations 700 may optionally begin, at block 702, where the wireless device may obtain a transmit power budget (or an indication thereof) associated with a time interval (e.g., the future time interval 306). For example, an inner loop (e.g., the inner loop 604) of the wireless device may obtain a transmit power budget associated with a future time interval. The transmit power budget may include or correspond to a maximum allowed time-averaged transmit power based on an RF exposure limit, for example, as described herein with respect to FIGS. 3 and 6. A transmit power budget may indicate the maximum allowed time-averaged transmit power that one or more radio(s) can use for the future time interval in compliance with the RF exposure limit. As a total transmit power budget of the wireless device may be shared among multiple radios across a rolling time window, the transmit power budget may indicate a time-averaged power that is less than or equal to Pₘₐₓ. In some cases, to obtain the transmit power budget, the wireless device may obtain the transmit power budget from a controller (e.g., the outer loop 602) that controls RF exposure associated with a plurality of RATs including a RAT associated with the connections. In certain cases, the inner loop may generate the transmit power budget, for example, when the inner loop is operating in a standalone mode without the periodic information (e.g., the second information 610) from the outer loop. To obtain the transmit power budget, the wireless device may generate the transmit power budget in a standalone mode.

At block 704, the wireless device may determine transmit powers on a per-connection basis among a plurality of connections (e.g., links and/or peers) based at least in part on the transmit power budget and one or more characteristics associated with the connections. For example, the wireless device may apply weights to each of the connections, where the weights may be determined based on the characteristic(s) associated with the connections. The transmit powers may satisfy a maximum time-averaged transmit power (e.g., Pₗᵢₘᵢₜ) associated with an RF exposure limit.

At block 704, the wireless device may transmit signals associated with the connections at the respective transmit powers in the time interval. For example, the wireless device may transmit the signals to a second wireless communication device (e.g., any of the second wireless devices 104 depicted in FIG. 1). The signals may indicate (or carry) any of various information, such as data or control information. To transmit the signals, the wireless device may transmit the signals via a plurality of links (e.g., links 414, 416) in the time interval, where each of the transmit powers is associated with a particular link among the links. For example, the wireless device may transmit the signals in MLO/MLA, SAP/multiple-STAs, or NAN connection (1:N). To transmit the signals, the wireless device may transmit the signals to a plurality of peers (e.g., STA(s) and/or AP(s) as shown in FIG. 1) in the time interval, where each of the transmit powers is associated with a particular peer among the peers.

In certain aspects, the connections may correspond to any wireless communication link. In some cases, the connections may correspond to multi-channel and/or multi-peer wireless communications. The connections may include a plurality of communication links and/or peers. In some cases, the links may be associated with multiple frequency channels, carriers, bands, etc. In certain cases, the links may be associated with the same frequency channel, carrier, band, etc. The connections may include a plurality of links (e.g., the links 414, 416) associated with a plurality of frequency channels (or sub-channels), a plurality of frequency carriers (or sub-carriers), a plurality of frequency bands (in WLAN or WWAN), a plurality of peers (e.g., STA(s) and/or AP(s)), or a combination thereof. In some cases, the links may be correspond to links for MLO/MLA in WLAN communications. A peer may include any receiver device, such as a STA, AP, base station, sensor, vehicle, aircraft, satellite, etc., for example, as depicted in FIG. 1.

For certain aspects, the connections may be associated with multiple RATs (e.g., WLAN, WWAN, Bluetooth, V2X, NTN, D2D, etc.) or a single RAT (e.g., WLAN or WWAN). In some cases, the frequency channels, bands, and/or carriers of the connections may be in a shared (e.g., unlicensed) spectrum and/or a licensed spectrum. The frequency bands may include a 2.4 GHz frequency band, a 5 GHz frequency band, a 6 GHz frequency band, or any combination thereof.

In certain aspects, the wireless device may request a transmit power budget for the time interval, for example, as described herein with respect to FIG. 6. The wireless device may determine a preliminary transmit power budget associated with the time interval based at least in part on the one or more characteristics associated with the connections. The wireless device may request the preliminary transmit power budget, and the wireless device may obtain the transmit power budget in response to requesting the preliminary transmit power budget.

To determine the transmit powers, the wireless device may determine the transmit powers based on a weight (e.g., wᵢ) associated with each of the connections. The wireless device may determine the weights based on the one or more characteristics associated with the connections. The one or more characteristics may comprise a signal strength (e.g., a received signal strength indicator (RSSI)), a data error rate (e.g., a block error rate, a frame error rate, a packet error rate, a bit error rate, etc.), a data error ratio (e.g., a block error ratio, a frame error ratio, a packet error ratio, a bit error ratio, etc.), a signal quality (e.g., a path loss, a channel quality indicator, a signal-to-noise ratio (SNR), a signal-to-interference plus noise ratio (SINR), a signal-to-noise plus distortion ratio (SNDR), etc.), a round-trip time (or latency), a channel condition, a duty cycle, a distance to another wireless device, a physical layer (PHY) characteristic, or any combination thereof. The physical layer characteristic may include any characteristic associated with the physical layer of a connection, such as channel or carrier frequency, channel or carrier bandwidth, modulation and coding scheme (MCS), coding rate, guard interval, number of spatial streams, etc. To determine the transmit powers, the wireless device may determine the transmit powers based on a sum of weighted signal strengths being less than or equal to the transmit power budget, for example, according to Expression (2). In certain aspects, the wireless device may apply a constrained optimization method to determine the transmit powers, such as a Lagrange multiplier, as described herein with respect to Expressions (1)-(5).

Aspects of the present disclosure may be applied to any of various wireless communication devices (wireless devices) that may emit RF signals causing exposure to human tissue, such as a handset, a wearable device (e.g., a watch, a ring, headphones, earbuds, a virtual (or augmented) reality headset, etc.), a base station, an access point, and/or a CPE, performing the RF exposure compliance described herein. It will also be appreciated that the RF exposure compliance is an example transmit power control. Other aspects of transmit power control may be applied to the present disclosure, including for example, RF emission limits, interference limits, RF saturation limits, etc.

### Example Communications Device

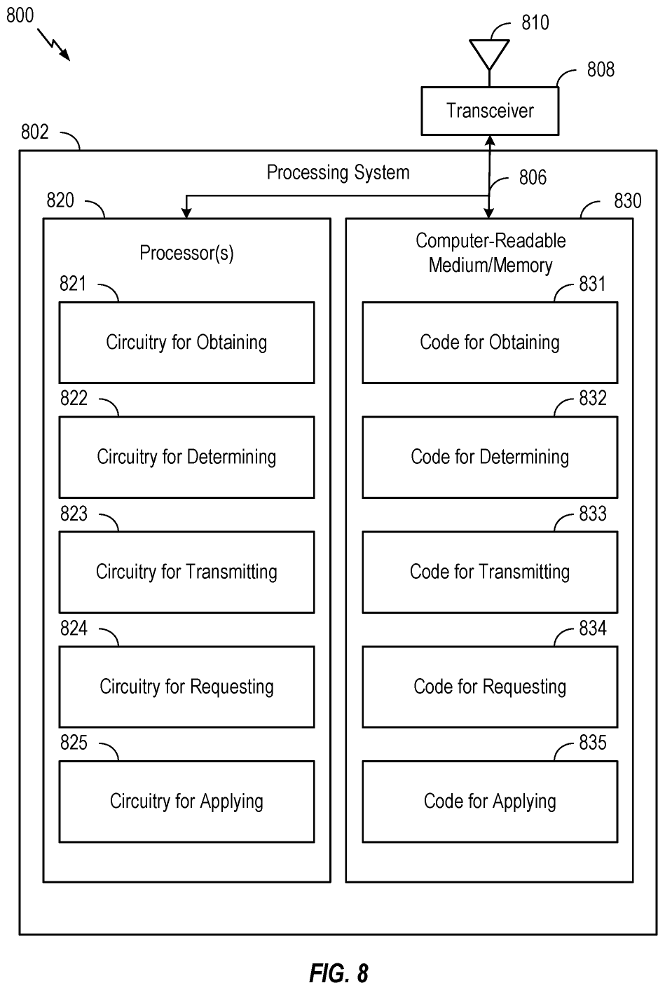

FIG. 8 depicts aspects of an example communications device 800. In some aspects, communications device 800 is a wireless communication device, such as the first wireless device 102 described above with respect to FIGS. 1 and 2.

The communications device 800 includes a processing system 802 coupled to a transceiver 808 (e.g., a transmitter and/or a receiver). The transceiver 808 is configured to transmit and receive signals for the communications device 800 via an antenna 810, such as the various signals as described herein. The processing system 802 may be configured to perform processing functions for the communications device 800, including processing signals received and/or to be transmitted by the communications device 800.

The processing system 802 includes one or more processors 820. In various aspects, the one or more processors 820 may be representative of any of the processor 210 and/or the modem 212, as described with respect to FIG. 2. The one or more processors 820 are coupled to a computer-readable medium/memory 830 via a bus 806. In certain aspects, the computer-readable medium/memory 830 is configured to store instructions (e.g., computer-executable code) that when executed by the one or more processors 820, cause the one or more processors 820 to perform the operations 700 described with respect to FIG. 7, or any aspect related to the operations described herein. Note that reference to a processor performing a function of communications device 800 may include one or more processors performing that function of communications device 800. Reference to one or more processors performing multiple functions may include any one of the one or more processors performing any one of the multiple functions.

In the depicted example, computer-readable medium/memory 830 stores code (e.g., executable instructions) for obtaining 831, code for determining 832, code for transmitting 833, code for requesting 834, code for applying 835, or any combination thereof. Processing of the code 831-835 may cause the communications device 800 to perform the operations 700 described with respect to FIG. 7, or any aspect related to operations described herein.

The one or more processors 820 include circuitry configured to implement (e.g., execute) the code stored in the computer-readable medium/memory 830, including circuitry for obtaining 821, circuitry for determining 822, circuitry for transmitting 823, circuitry for requesting 824, circuitry for applying 825, or any combination thereof. Processing with circuitry 821-825 may cause the communications device 800 to perform the operations 700 described with respect to FIG. 7, or any aspect related to operations described herein.

Various components of the communications device 800 may provide means for performing the operations 700 described with respect to FIG. 7, or any aspect related to operations described herein. For example, means for transmitting, sending or outputting for transmission may include the TX path 214 and/or antenna(s) 218 of the first wireless device 102 illustrated in FIG. 2 and/or transceiver 808 and antenna 810 of the communications device 800 in FIG. 8. In some cases, means for receiving or obtaining may include the RX path 216 and/or antenna(s) 218 of the first wireless device illustrated in FIG. 2 and/or transceiver 808 and antenna 810 of the communications device 800 in FIG. 8. Means for obtaining, means for determining, means for requesting, and/or means for applying may include one or more processors, such as the processor 210 and/or modem 212 depicted in FIG. 2 and/or the processor(s) 820 in FIG. 8.

### Example Aspects

Implementation examples are described in the following numbered clauses:

Aspect 1: A method of wireless communication by a wireless device, comprising: obtaining a transmit power budget associated with a time interval; determining transmit powers on a per-connection basis among a plurality of connections based at least in part on the transmit power budget and one or more characteristics associated with the connections; and transmitting signals associated with the connections at the respective transmit powers in the time interval.

Aspect 2: The method of Aspect 1, wherein the connections comprise a plurality of links associated with a plurality of frequency channels, a plurality of frequency carriers, a plurality of frequency bands, a plurality of peers, or a combination thereof.

Aspect 3: The method of Aspect 2, wherein the frequency bands are in a shared spectrum.

Aspect 4: The method of Aspect 2 or 3, wherein the frequency bands include a 2.4 GHz frequency band, a 5 GHz frequency band, a 6 GHz frequency band, or any combination thereof.

Aspect 5: The method according to any of Aspects 1-4, wherein the connections are associated with wireless local area network (WLAN) communications, wireless wide area network (WWAN) communications, or any combination thereof.

Aspect 6: The method according to any of Aspects 1-5, wherein transmitting the signals comprises transmitting the signals via a plurality of links in the time interval and wherein each of the transmit powers is associated with a particular link among the links.

Aspect 7: The method according to any of Aspects 1-6, wherein transmitting the signals comprises transmitting the signals to a plurality of peers in the time interval and wherein each of the transmit powers is associated with a particular peer among the peers.

Aspect 8: The method according to any of Aspects 1-7, wherein the transmit power budget comprises a maximum allowed time-averaged transmit power based on a radio frequency (RF) exposure limit.

Aspect 9: The method of Aspects 8, wherein the transmit powers satisfy a maximum time-averaged transmit power associated with the RF exposure limit.

Aspect 10: The method according to any of Aspects 1-9, wherein obtaining the transmit power budget comprises obtaining the transmit power budget from a controller that controls radio frequency (RF) exposure associated with a plurality of radio access technologies including a radio access technology associated with the connections.

Aspect 11: The method according to any of Aspects 1-10, wherein obtaining the transmit power budget comprises generating the transmit power budget in a standalone mode.

Aspect 12: The method according to any of Aspects 1-11, further comprising: determining a preliminary transmit power budget associated with the time interval based at least in part on the one or more characteristics associated with the connections; and requesting the preliminary transmit power budget, wherein obtaining the transmit power budget comprises obtaining the transmit power budget in response to requesting the preliminary transmit power budget.

Aspect 13: The method according to any of Aspects 1-12, wherein determining the transmit powers comprises determining the transmit powers based on a weight associated with each of the connections.

Aspect 14: The method of Aspect 13, wherein determining the transmit powers comprises determining the weights based on the one or more characteristics associated with the connections.

Aspect 15: The method according to any of Aspects 1-14, wherein the one or more characteristics comprise: a signal strength, a data error rate, a data error ratio, a signal quality, a round-trip time, a channel condition, a duty cycle, a distance to another wireless device, a physical layer characteristic, or any combination thereof.

Aspect 16: The method according to any of Aspects 1-15, wherein determining the transmit powers comprises determining the transmit powers based on a sum of weighted transmit powers being less than or equal to the transmit power budget.

Aspect 17: The method according to any of Aspects 13-16, wherein determining the transmit powers comprises applying a constrained optimization method that uses the weight associated with each of the connections to determine the transmit powers.

Aspect 18: The method of Aspect 17, wherein the constrained optimization method applies a Lagrange multiplier.

Aspect 19: An apparatus for wireless communication, comprising: a memory; and one or more processors coupled to the memory, the one or more processors being configured to: obtain a transmit power budget associated with a time interval; determine transmit powers on a per-connection basis among a plurality of connections based at least in part on the transmit power budget and one or more characteristics associated with the connections; and control transmission of signals associated with the connections at the respective transmit powers in the time interval.

Aspect 20: The apparatus of Aspect 19, further comprising one or more transmitters coupled to the one or more processors, the one or more transmitters being configured to transmit the signals associated with the connections at the respective transmit powers in the time interval, wherein the connections comprise a plurality of links associated with a plurality of frequency channels, a plurality of frequency carriers, a plurality of frequency bands, a plurality of peers, or a combination thereof.

Aspect 21: The apparatus of Aspect 20, wherein the frequency bands are in a shared spectrum.

Aspect 22: The apparatus according to any of Aspects 19-21, wherein the connections are associated with wireless local area network (WLAN) communications, wireless wide area network (WWAN) communications, or any combination thereof.

Aspect 23: The apparatus according to any of Aspects 19-22, wherein the transmit power budget comprises a maximum allowed time-averaged transmit power based on a radio frequency (RF) exposure limit.

Aspect 24: The apparatus according to any of Aspects 19-23, wherein to determine the transmit powers, the one or more processors are further configured to determine the transmit powers based on a weight associated with each of the connections.

Aspect 25: The apparatus according to any of Aspects 19-24, wherein the one or more characteristics comprise: a signal strength, a data error rate, a data error ratio, a signal quality, a round-trip time, a channel condition, a duty cycle, a distance to another wireless device, a physical layer characteristic, or any combination thereof.

Aspect 26: The apparatus according to any of Aspects 19-25, wherein to determine the transmit powers, the one or more processors are further configured to determine the transmit powers based on a sum of weighted transmit powers being less than or equal to the transmit power budget.

Aspect 27: The apparatus according to any of Aspects 19-26, wherein to determine the transmit powers, the one or more processors are further configured to apply a constrained optimization method that uses the weight associated with each of the connections to determine the transmit powers.

Aspect 28: The apparatus of Aspect 27, wherein the constrained optimization method applies a Lagrange multiplier.

Aspect 29: An apparatus for wireless communication, comprising: means for obtaining a transmit power budget associated with a time interval; means for determining transmit powers on a per-connection basis among a plurality of connections based at least in part on the transmit power budget and one or more characteristics associated with the connections; and means for transmitting signals associated with the connections at the respective transmit powers in the time interval.

Aspect 30: A computer-readable medium having instructions stored thereon for: obtaining a transmit power budget associated with a time interval; determining transmit powers on a per-connection basis among a plurality of connections based at least in part on the transmit power budget and one or more characteristics associated with the connections; and transmitting signals associated with the connections at the respective transmit powers in the time interval.

Aspect 31: An apparatus, comprising: a memory comprising computer-executable instructions; and one or more processors configured to execute the computer-executable instructions and cause the apparatus to perform a method in accordance with any of Aspects 1-18.

Aspect 32: An apparatus, comprising means for performing a method in accordance with any of Aspects 1-18.

Aspect 33: A non-transitory computer-readable medium comprising computer-executable instructions that, when executed by one or more processors of a processing system, cause the processing system to perform a method in accordance with any of Aspects 1-18.

Aspect 34: A computer program product embodied on a computer-readable storage medium comprising code for performing a method in accordance with any of Aspects 1-18.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a microcontroller, a microprocessor, a general-purpose processor, a digital signal processor (DSP), a neural network processor, an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory), and the like. Also, “determining” may include resolving, selecting, identifying, mapping, applying, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” The use of a definite article (e.g., “the” or “said”) before an element is not intended to impart a singular meaning (e.g., “one and only one”) on an otherwise plural meaning (e.g., “one or more”) associated with the element unless specifically so stated. Unless specifically stated otherwise, the term “some” refers to one or more. No claim element is to be construed under the provisions of 35 U.S.C. § 112 (f) unless the element is expressly recited using the phrase “means for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method of wireless communication by a wireless device, comprising:
obtaining a transmit power budget associated with a time interval;
determining transmit powers on a per-connection basis among a plurality of connections based at least in part on the transmit power budget and one or more characteristics associated with the connections; and
transmitting signals associated with the connections at the respective transmit powers in the time interval.

2. The method of claim 1, wherein the connections comprise a plurality of links associated with a plurality of frequency channels, a plurality of frequency carriers, a plurality of frequency bands, a plurality of peers, or a combination thereof.

3. The method of claim 2, wherein the frequency bands are in a shared spectrum.

4. The method of claim 2, wherein the frequency bands include a 2.4 GHz frequency band, a 5 GHz frequency band, a 6 GHz frequency band, or any combination thereof.

5. The method of claim 1, wherein the connections are associated with wireless local area network (WLAN) communications, wireless wide area network (WWAN) communications, or any combination thereof.

6. The method of claim 1, wherein transmitting the signals comprises transmitting the signals via a plurality of links in the time interval and wherein each of the transmit powers is associated with a particular link among the links.

7. The method of claim 1, wherein transmitting the signals comprises transmitting the signals to a plurality of peers in the time interval and wherein each of the transmit powers is associated with a particular peer among the peers.

8. The method of claim 1, wherein the transmit power budget comprises a maximum allowed time-averaged transmit power based on a radio frequency (RF) exposure limit.

9. The method of claim 8, wherein the transmit powers satisfy a maximum time-averaged transmit power associated with the RF exposure limit.

10. The method of claim 1, wherein obtaining the transmit power budget comprises obtaining the transmit power budget from a controller that controls radio frequency (RF) exposure associated with a plurality of radio access technologies including a radio access technology associated with the connections.

11. The method of claim 1, wherein obtaining the transmit power budget comprises generating the transmit power budget in a standalone mode.

12. The method of claim 1, further comprising:
determining a preliminary transmit power budget associated with the time interval based at least in part on the one or more characteristics associated with the connections; and
requesting the preliminary transmit power budget, wherein obtaining the transmit power budget comprises obtaining the transmit power budget in response to requesting the preliminary transmit power budget.

13. The method of claim 1, wherein determining the transmit powers comprises determining the transmit powers based on a weight associated with each of the connections.

14. The method of claim 13, wherein determining the transmit powers comprises determining the weights based on the one or more characteristics associated with the connections.

15. The method of claim 1, wherein the one or more characteristics comprise:
a signal strength,
a data error rate,
a data error ratio,
a signal quality,
a round-trip time,
a channel condition,
a duty cycle,
a distance to another wireless device,
a physical layer characteristic, or
any combination thereof.

16. The method of claim 1, wherein determining the transmit powers comprises determining the transmit powers based on a sum of weighted transmit powers being less than or equal to the transmit power budget.

17. The method of claim 13, wherein determining the transmit powers comprises applying a constrained optimization method that uses the weight associated with each of the connections to determine the transmit powers.

18. The method of claim 17, wherein the constrained optimization method applies a Lagrange multiplier.

19. An apparatus for wireless communication, comprising:
a memory; and
one or more processors coupled to the memory, the one or more processors being configured to:
obtain a transmit power budget associated with a time interval;
determine transmit powers on a per-connection basis among a plurality of connections based at least in part on the transmit power budget and one or more characteristics associated with the connections; and
control transmission of signals associated with the connections at the respective transmit powers in the time interval.

20. The apparatus of claim 19, further comprising one or more transmitters coupled to the one or more processors, the one or more transmitters being configured to transmit the signals associated with the connections at the respective transmit powers in the time interval, wherein the connections comprise a plurality of links associated with a plurality of frequency channels, a plurality of frequency carriers, a plurality of frequency bands, a plurality of peers, or a combination thereof.

21. The apparatus of claim 20, wherein the frequency bands are in a shared spectrum.

22. The apparatus of claim 19, wherein the connections are associated with wireless local area network (WLAN) communications, wireless wide area network (WWAN) communications, or any combination thereof.

23. The apparatus of claim 19, wherein the transmit power budget comprises a maximum allowed time-averaged transmit power based on a radio frequency (RF) exposure limit.

24. The apparatus of claim 19, wherein to determine the transmit powers, the one or more processors are further configured to determine the transmit powers based on a weight associated with each of the connections.

25. The apparatus of claim 19, wherein the one or more characteristics comprise:
a signal strength,
a data error rate,
a data error ratio,
a signal quality,
a round-trip time,
a channel condition,
a duty cycle,
a distance to another wireless device,
a physical layer characteristic, or
any combination thereof.

26. The apparatus of claim 19, wherein to determine the transmit powers, the one or more processors are further configured to determine the transmit powers based on a sum of weighted transmit powers being less than or equal to the transmit power budget.

27. The apparatus of claim 24, wherein to determine the transmit powers, the one or more processors are further configured to apply a constrained optimization method that uses the weight associated with each of the connections to determine the transmit powers.

28. The apparatus of claim 27, wherein the constrained optimization method applies a Lagrange multiplier.

29. An apparatus for wireless communication, comprising:
means for obtaining a transmit power budget associated with a time interval;
means for determining transmit powers on a per-connection basis among a plurality of connections based at least in part on the transmit power budget and one or more characteristics associated with the connections; and
means for transmitting signals associated with the connections at the respective transmit powers in the time interval.

30. A computer-readable medium having instructions stored thereon for:
obtaining a transmit power budget associated with a time interval;
determining transmit powers on a per-connection basis among a plurality of connections based at least in part on the transmit power budget and one or more characteristics associated with the connections; and
transmitting signals associated with the connections at the respective transmit powers in the time interval.
